(19) United States
(12) Patent Application Publication
(10) Pub. No.: US 2013/0296088 A1
(43) Pub. Date: Nov. 7, 2013

(54) DRIVE TRAIN FOR A HYBRID VEHICLE

(71) Applicant: Peter Savage, Graz (AT)

(72) Inventor: Peter Savage, Graz (AT)

(73) Assignee: AVL LIST GMBH, Graz, AT (unknown)

(21) Appl. No.: 13/880,779

(22) PCT Filed: Oct. 13, 2011
(86) PCT No.: PCT/EP11/67869

§ 371 Date: Jul. 8, 2013

(30) Foreign Application Priority Data
Oct. 21, 2010 (AT) A1755/2010

(51) Int. Cl. F16H 37/06

(52) U.S. Cl. CPC F16H 37/065; Y10S 903/902
USPC 475/5; 180/65.22; 903/902

(57) ABSTRACT

A drive train for a hybrid vehicle, and which includes an internal combustion engine, at least one electric machine, a first planetary gear and a second planetary gear between a transmission input shaft, which is in drive connection to the output shaft of the internal combustion engine, and a transmission output shaft.

### CROSS-REFERENCE TO RELATED APPLICATIONS

The present application is a National Stage Application of PCT International Application No. PCT/EP2011/067869 (filed on Oct. 13, 2011), under 35 U.S.C. §371, which claims priority to Austrian Patent Application No. A 1755/2010 (filed on Oct. 21, 2010), which are each hereby incorporated by reference in their respective entireties.

### TECHNICAL FIELD

The invention relates to a drive train for a hybrid vehicle, comprising an internal combustion engine, at least one electric machine, a first planetary gear and a second planetary gear between a transmission input shaft which is in drive connection to the output shaft of the internal combustion engine, and a transmission output shaft, with each planetary gear comprising the components of a sun gear, planet carrier and ring gear, and with the transmission input shaft being in drive connection to a first component of the first planetary gear, and the first planetary gear and the second planetary gear are arranged in series one behind the other in the drive train and are in drive connection to each other via a second component similar for both planetary gears, and with a third component of at least one of the two planetary gears being connectable to a braking device.

### BACKGROUND

Drive trains for series-hybrid vehicles with an internal combustion engine and at least one electric machine are known from the publications U.S. Pat. No. 6,026,921 A, DE 10 229 535 A1 and U.S. Pat. No. 7,347,803 A. In the case of such drive trains, which are known as full hybrid systems, the vehicle can be operated optionally alone by the electric motor without any support of the internal combustion engine. The internal combustion engine will be switched in from a specific operating point, as a result of which the drive will occur by combination of the internal combustion engine with the electric motor. A shifting clutch is required for connecting and disconnecting the internal combustion engine to and from the remaining drive train. It is disadvantageous that additional space needs to be provided for the shifting clutch.

Hybrid drive trains with planetary gear sets are further known which are used as power-splitting transmissions, with an electric machine and an internal combustion engine acting on different components of the planetary gear and with the output occurring via a further component of the planetary gear. Such an arrangement is known for example from DE 10 2007 054 361 A1. It is disadvantageous that the electric machine needs to provide torque continuously in order to transfer drive torque of the internal combustion engine into the drive train.

### SUMMARY

It is the object of the invention to provide a simple and compact drive train for a hybrid vehicle.

This is achieved in accordance with the invention in such a way that the first and the second planetary gear are designed identically, that the braking device acts on a third component of the first planetary gear, with preferably a similar third component of the second planetary gear being arranged to be fixed to the housing, and that a first component of the second planetary gear, which is similar to the first component of the first planetary gear, is in drive connection to the transmission output shaft.

The electric machine can be in drive connection to the first or second component of the second planetary gear.

It is provided in a very simple and compact embodiment that the second component is respectively formed by the ring gear of the planetary gear. For the purpose of rigid drive connection, the ring gears of the first and second planetary gear can be provided with an integral arrangement.

It is especially advantageous if the first component is formed by the sun gear and the third component by the planet carrier of the planetary gear. It is alternatively also possible that the first component is formed by the planet carrier and the third component by the sun gear of the planetary gear.

It is a common aspect of all embodiments that the drive train is arranged without any switchable shaft coupling, so that the internal combustion engine is continually and fixedly connected to the first component of the first planetary gear and the transmission output shaft is continually and fixedly connected to the similar first component of the second planetary gear.

Since switchable shaft couplings can be avoided completely in the drive train between the internal combustion engine and the output shaft of the vehicle, it is possible to save overall space and components on the one hand, and very simple triggering for the changeover between the two drive machines can be achieved on the other hand.

### DRAWINGS

The invention will be explained below in closer detail by reference to the drawings, which schematically illustrate as follows:

FIG. 1 illustrates a drive train in accordance with the invention in a first embodiment.

FIG. 2 illustrates a drive train in accordance with the invention in a second embodiment.

FIG. 3 illustrates a drive train in accordance with the invention in a third embodiment.

### DESCRIPTION

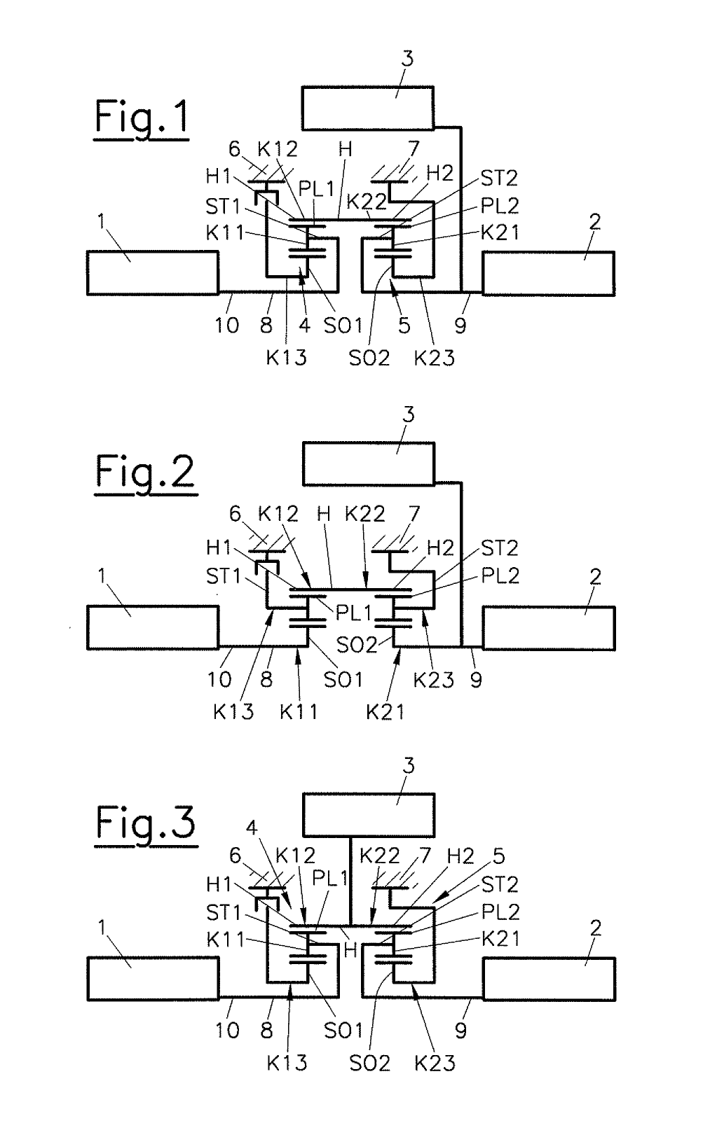

FIGS. 1 to 3 illustrate a drive train for a hybrid vehicle, comprising an internal combustion engine 1, an electric machine 3, a first planetary gear 4 and a second planetary gear 5. The remaining drive train on the transmission output side including the differential and the drive wheels is indicated by reference numeral 2. The output shaft 10 of the internal combustion engine 1 is directly connected to the transmission input shaft 8, and said shaft 8 is directly connected to a first component K11 of the first planetary gear 4. A similar first component K21 of the second planetary gear 5 is directly connected via the transmission output shaft 9 to the drive train 2 on the side of the output wheels.

Each of the two planetary gears 4, 5 comprises a sun gear SO1, SO2, a planet carrier ST1, ST2 with planet wheels PL1, PL2 and a ring gear H1, H2.

As will be explained below in closer detail, the first component K11, K21 can either be the planet carrier ST1, ST2, or the sun gear SO1, SO2, wherein it is relevant that the first component K11, K21 is formed in one respective arrangement by the same part, i.e. either the sun gear or the planet carrier. Similar shall therefore mean in this context that the first component is formed by the same component in the first planetary gear 4 and in the second planetary gear 5.

A second component K12 of the first planetary gear 4 is rigidly in drive connection to a similar second component K22 of the second planetary gear 5. In all embodiments as illustrated herein, the second component K12, K22 is formed by the ring gears H1, H2 of the two planetary gears 4, 5, wherein the ring gears H1, H2 of both planetary gears can advantageously be arranged in an integral fashion and therefore as a common ring gear unit H.

A third component K13 of the first planetary gear 4 can be braked via a braking device 6. The similar third component K23 of the second planetary gear 5 is rigidly held, i.e. it is tightly connected to the housing 7 of the planetary gear 5. In analogy to the first component, the third component K13, K23 can either be the sun gear SO1, SO2 or the planet carrier ST1, ST2, wherein it is also relevant in this case that the third component K13, K23 is formed in one respective arrangement by the same part, i.e. either the planet carrier or the sun gear. Similar shall also mean in this case that the third component is formed by the same component in the first planetary gear 4 and in the second planetary gear 5.

The first and second planetary gear 4, 5 can advantageously be arranged in a common housing 7.

In FIG. 1, the first components K11, K21 of the first and second planetary gear 4, 5 are formed by the planet carriers ST1, ST2. The sun gears SO1, SO2 of the planetary gears 4, 5 form the third components K13, K23. The electric machine 3 is directly connected to the transmission output shaft 9.

FIG. 3 differs from the embodiment illustrated in FIG. 1 in such a way that the electric machine 3 acts directly on the common ring gear H. The remainder of the arrangement corresponds to the one of FIG. 1.

The embodiment as illustrated in FIG. 2 differs from the embodiment as illustrated in FIG. 1 in such a way that the first components K11, K21 are respectively formed by the sun gears SO1, SO2 of the planetary gears 4, 5 and the third components K13, K23 are respectively formed by the planet carriers ST1, ST2 of the two planetary gears 4, 5. Consequently, the internal combustion engine 1 is connected directly via the transmission output shaft 8 to the sun gear SO1 of the first planetary gear 4. Furthermore, the transmission output shaft 9 is directly connected to the sun gear SO2 of the second planetary gear 5. The braking device 6 acts on the planet carrier ST1 of the first planetary gear 4.

The torque of the internal combustion engine 1 can be connected or disconnected in a continuously variable manner by actuating the braking device 6 which can be formed by a brake band for example. A highly cost-effective compact drive train arrangement is enabled by the similarly arranged planetary gears 4, 5, wherein switchable shaft couplings can be omitted completely.

1-15. (canceled)

16. A drive train for a hybrid vehicle, comprising:
an internal combustion engine having an output shaft;
at least one electric machine;
a transmission input shaft in drive connection to the output shaft;
a transmission output shaft;
first and second planetary gears arranged in series between the transmission input shaft and the transmission output shaft, each planetary gear including a sun gear, a planet carrier and a ring gear; and
a braking device,
wherein:
the transmission input shaft is in drive connection to a first component of the first planetary gear,
the first planetary gear and the second planetary gear are in drive connection to each other via a common second component,
a third component of the first planetary gear is operatively connected to the braking device such that the braking device acts on the third component,
a first component of the second planetary gear which is common to the first component of the first planetary gear is in drive connection to the transmission output shaft, and
a third component of the second planetary gear which is common to the third component of the first planetary gear is configured to be fixed to a housing of the second planetary gear.

17. The drive train of claim 16, wherein the torque of the internal combustion engine is configured for connection in a continuously variable manner by actuating the braking device.

18. The drive train of claim 16, wherein the electric machine is in drive connection to the first component or the second component of the second planetary gear.

19. The drive train of claim 16, wherein the second component of the first planetary gear and the second component of the second planetary gear each comprises the ring gear.

20. The drive train of claim 19, wherein each ring gear is integrally arranged.

21. The drive train of claim 16, wherein the first component of the first planetary gear and the first component of the second planetary gear each comprises the planet carrier.

22. The drive train of claim 21, wherein the third component of the first planetary gear and the third component of the second planetary gear each comprises the sun gear.

23. The drive train of claim 16, wherein the first component of the first planetary gear and the first component of the second planetary gear each comprises the sun gear.

24. The drive train of claim 16, wherein the third component of the first planetary gear and the third component of the second planetary gear each comprises the planet carrier.

25. The drive train of claim 16, wherein the drive train is arranged without switchable shaft couplings such that the internal combustion engine is continually and fixedly in drive connection to the first component of the first planetary gear.

26. The drive train of claim 25, wherein the transmission output shaft is continually and fixedly in drive connection to the first component of the second planetary gear.

27. A drive train for a hybrid vehicle, comprising:
an internal combustion engine;
an electric machine;
a transmission input shaft in drive connection to the output shaft;
a transmission output shaft;
a first planetary gear operatively connected to the transmission input shaft and including a first sun gear, a first planet carrier and a first ring gear;
a second planetary gear arranged in series and in drive connection with the first planetary gear and operatively connected to the transmission output shaft, the second planetary gear including a second sun gear, a second planet carrier and a second ring gear;
a first braking device operatively connected to the first planetary gear; and
a second braking device operatively connected to the second planetary gear,
wherein:
a first component of the second planetary gear which is common to the first component of the first planetary gear is in drive connection to the transmission output shaft.

28. The drive train of claim 27, wherein the transmission input shaft is in drive connection to the first planet carrier.

29. The drive train of claim 27, wherein the transmission input shaft is in drive connection to the first sun gear.

30. The drive train of claim 27, wherein the first planetary gear and the second planetary gear are in drive connection to each other via the first ring gear and the second ring gear.

31. The drive train of claim 27, wherein the first sun gear is operatively connected to the first braking device.

32. The drive train of claim 27, wherein the first planet carrier is operatively connected to the first braking device.

33. The drive train of claim 27, wherein the second planet carrier or the second sun gear is in drive connection to the transmission output shaft.

34. The drive train of claim 27, wherein the transmission output shaft is continually and fixedly in drive connection to the second planet carrier.

35. The drive train of claim 27, wherein the transmission output shaft is continually and fixedly in drive connection to the second sun gear.
